(19) United States
(12) Patent Application Publication
(10) Pub. No.: US 2008/0319570 A1
(43) Pub. Date: Dec. 25, 2008

(54) SYSTEM AND METHOD FOR FASTENER INSTALLATION

(76) Inventor: Michael M. Van Schoiack, Bellevue, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 12/146,311

(22) Filed: Jun. 25, 2008

Related U.S. Application Data
(60) Provisional application No. 60/946,025, filed on Jun. 25, 2007.

(51) Int. Cl. G06F 19/00

(52) U.S. Cl. 700/110

(57) ABSTRACT

A system for monitoring installation of fasteners in an assembly process utilizes printed symbology, such as a barcode, to uniquely identify the location at which a fastener will be installed. An installation tool includes torque measuring capability and further includes a reader capable of reading the printed symbology. The output of the reader and the torque measurement values are provided to a computer communicatively coupled thereto. The computer contains stored fastener torque signatures that correspond to each fastener. Based on the printed symbology identification, the computer can determine the type of fastener to be installed at that precise location. During installation, torque measurements from the installation tool are compared against the fastener torque signature to determine whether the proper fastener was installed at that location and, additionally, whether the fastener was properly installed. Based on the torque measurement and rotational position of the fastener, the system can identify a number of different types of defects, such as improper selection of the fastener; thread defects, cross threading, and the like.

### BACKGROUND OF THE INVENTION

1. Field of the Invention

The present invention is directed generally to fasteners, such as nuts and bolts, and, more particularly, to a system and method for fastener installation.

2. Description of the Related Art

Quality control of the manufacturing of a mechanical device such as a vehicle or machine requires that one knows that the proper fastener is installed at each fastener site, that the fastener and the threaded hole are defect-free and that the fastener is properly torqued. Tools for torquing fasteners with built-in torque measuring means are in common use in the industry. However, it is left to the operator and the manufacturing supply system to insure that the proper fastener is installed, that the fastener and thread are defect-free and that the torque measurement applies to the proper location. Torque measuring tools do not eliminate error caused by improper fasteners being installed at a location, nor is there any correlation other than operator indication of a torque measurement relation to a particular fastener, or of repeated torque measurements at a given fastener. In addition, present tools do not have the means to determine if there are defects in the threads or if metal shavings are present that can cause improper torquing.

Therefore, it can be appreciated that there is a significant need for a system and a method to monitor fastener installation to assure that the proper fastener has been installed at the proper location and that the fastener has been properly installed. The present invention provides this and other advantages as will be apparent from the following detailed description and accompanying figures.

### BRIEF DESCRIPTION OF THE SEVERAL VIEWS OF THE DRAWING(S)

FIG. 1 is a functional block diagram of a fastener installation system constructed in accordance with the present teachings.

FIG. 2 is a block diagram illustrating various computer architectures used to implement the system of FIG. 1.

FIG. 3 is diagrammatically illustrates a printed symbology proximate a fastener and the fastener installation tool.

FIG. 4 illustrates a different embodiment of the installation tool of FIG. 1.

FIGS. 5A and 5B are waveforms illustrating the relationship of torque and rotational position of a fastener with respect to time.

FIG. 6A is series of waveforms illustrating multiple example signatures relating torque to rotational position of a fastener.

FIG. 6B is a waveform of a normal fastener torque signature with upper and lower limits graphically displayed.

FIG. 7 is a flowchart illustrating the operation of the system of FIG. 1 to collect data to thereby develop a signature.

FIG. 8 is a flowchart illustrating the operation of the system of FIG. 1 to collect and analyze data during the installation of a fastener.

### DETAILED DESCRIPTION OF THE INVENTION

The present techniques insure that each fastener is properly installed and that it is the proper fastener. The system described herein collects data during the actual installation process and compares the collected data to a stored data indicative of a normal installation. The data generated during installation of a fastener may be referred to herein as a “signature.” The data indicative of a satisfactory installation may be referred to herein as a “gold standard” signature. By comparing the actual installation signature with the stored gold standard signature, the system determines that a fastener is installed to the proper torque, and that the fastener and threads are defect-free using actual measured parameter values. This system described herein acquires this information during the normal manufacturing fastener installation process, eliminating the need for a separate inspection or measurement. This procedure does not add any appreciable time to do the assembly process—in fact it reduces the total assembly time if a separate inspection is made for quality purposes.

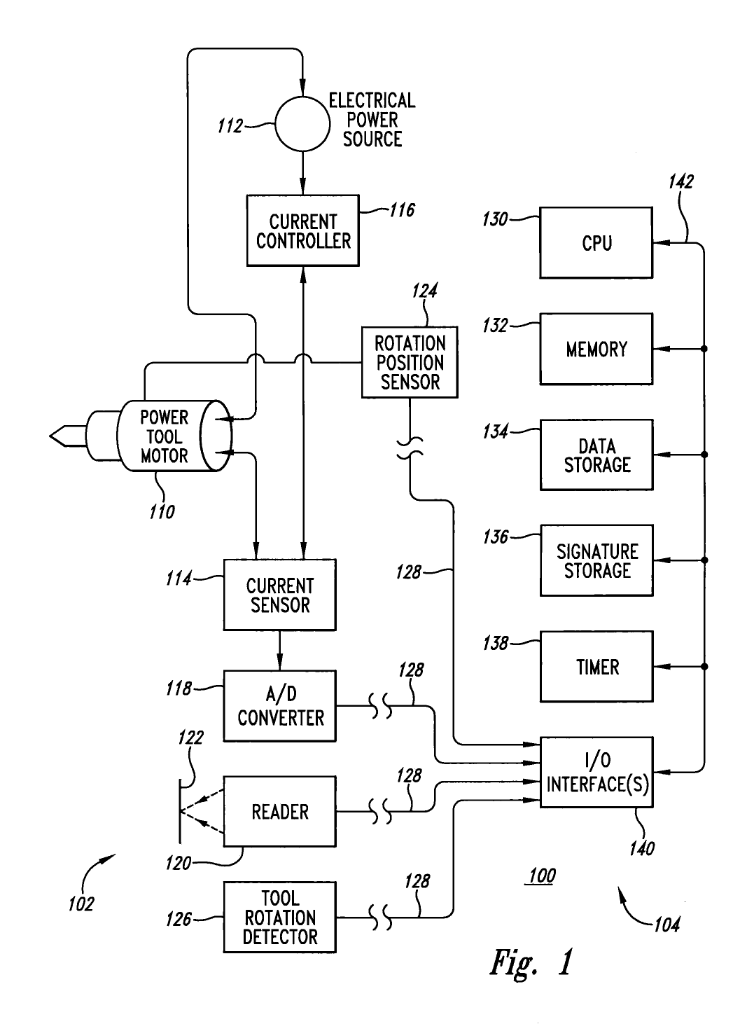

FIG. 1 is a functional block diagram illustrating an exemplary implementation of a measurement system constructed in accordance with the present teachings. A system 100 includes an installation tool 102 and a computer 104. Each component will be described in greater detail below. In general, the installation tool 102 is operated by an assembly worker to install the fastener. However, the principles describes herein are applicable to automated machinery that may be used to install a fastener without human operation. The term “fastener” is intended to encompass any rotationally installed component, such as a nut or bolt. As will be described in greater detail below, the system 100 measures torque with respect to rotational position of a fastener as the fastener is installed by the assembly worker at a fastener mate location. A fastener mate is a mate to the fastener. For example, if the fastener is a bolt, the fastener mate may be a threaded stud sized to receive the bolt. The measured data is compared against a signature pattern to determine whether the installation comports with expected values or whether it deviates in some manner. Furthermore, the manner in which the installation deviates from the expected norm can be used as an indicator of the nature of the installation error.

The installation tool 102 comprises a power tool motor 110, which is plugged into an electrical power source 112. The electrical power source 112 may be a conventional power source connected to an electrical power grid, a power generator, or a battery power source. The installation tool 102 includes a current sensor 114 and a current controller 116, which function to measure the current drawn by the motor 110. Those skilled in the art will appreciate that the current measurement at any given time can be used as an indicator of the torque exerted by the installation tool 102. The current measurement signal is an analog signal converted to a digital signal by an analog-to-digital converter (ADC) 118.

The current controller 116 may also be used to limit current to the power motor tool 110 thus controlling the maximum torque produced by the installation tool 102. As will be described in greater detail below, the operation of the current controller 116 can be used to limit the torque generated by the installation tool 102 to prevent damage to the fastener in the event of a cross-threaded fastener or if the wrong fastener is inadvertently selected by the assembly worker.

Although the installation tool 102 presented in FIG. 1 is an electrically powered installation tool, those skilled in the art will appreciate that assembly is often performed by a pneumatically driven installation tool. The principles of the system 100 also apply to a pneumatically driven installation tool. Those skilled in the art will appreciate that the pressure used to drive the tool as well as the speed of the tool can be used to indirectly measure torque for a pneumatically driven installation tool. Thus, the same principles apply whereby torque will be measured and compared to a torque signature pattern to assure proper selection of the fastener and proper installation of the fastener.

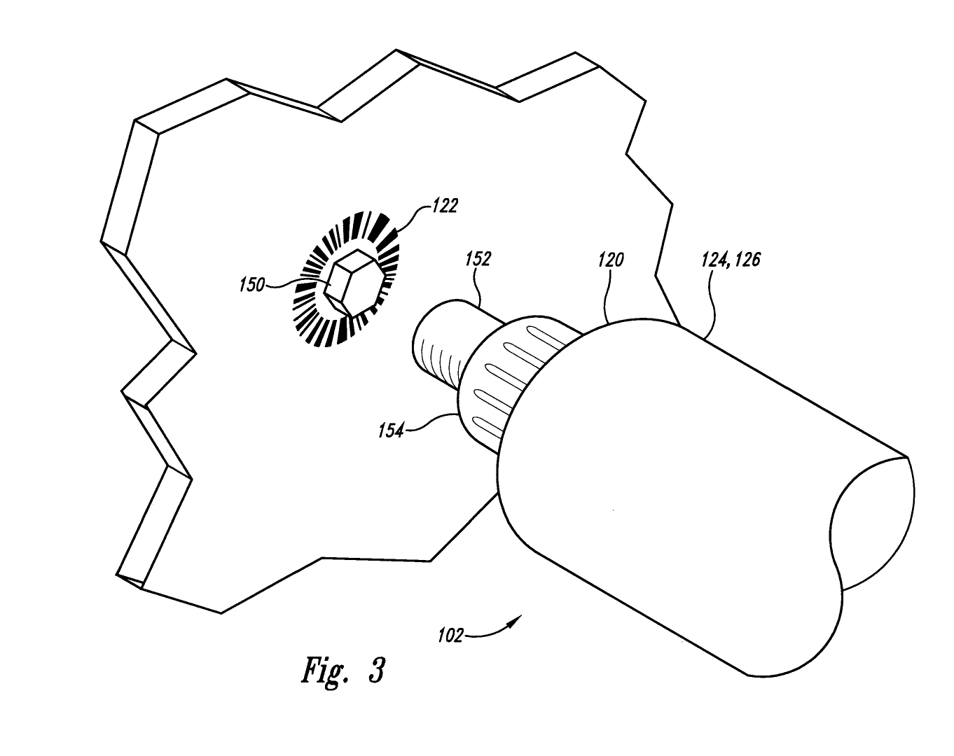

In addition to the torque sensing circuitry provided by the current sensor 114, the installation tool 102 includes a reader 120, such as a camera or a barcode scanner. As will be described in greater detail below, the reader 120 is capable of reading and decoding printed symbology 122. In one embodiment, the printed symbology may be a barcode positioned about the installation site of the fastener (see FIG. 3). Although illustrated herein as a barcode, those skilled in the art will appreciate that the printed symbology can take many different forms. The printed symbology 122 illustrated in FIG. 3 is arranged in a perimeter region around the location at which the fastener will be installed. The printed symbology 122 identifies the location for the particular fastener. This identification information is used by the computer 104 to determine which fastener should be used at this location and to identify the signature pattern for the particular fastener associated with the particular location. In addition, in one embodiment the printed symbology 122 may be used by the reader 120 to determine the rotational position of the rotating part (e.g., the chuck) of the installation tool 102.

The installation tool 102 also includes a rotation position sensor 124. The rotation position sensor 124 measures the rotational position of the installation tool. As will be described in greater detail below, the torque signature pattern for any given fastener is determined as a function of the rotational position of that fastener. The speed of the installation tool 102 may also be measured by the rotation position sensor 124 by measuring the change in angle over some unit of time. The rotation position sensor 124 can be a conventional device, such as a rotational encoder. A rotational encoder produces a predetermined number of pulses per revolution thus providing an accurate measure of the rotation of the power tool motor 110. The rotation position sensor 124 may also be implemented using a variety of other known technologies for rotation detection. The system 100 is not intended to be limited by any specific form of sensor used to implement the rotation position sensor 124.

Also illustrated in FIG. 1 is a tool rotation detector 126. The tool rotation detector 126 detects an actual change in the overall position of the installation tool 102. For example, if the installation tool 102 is hand operated by an assembly worker, it is possible that the assembly worker will allow rotation of the installation tool 102 itself during the installation process. This could result in an error in the output rotation position sensor 124 because a portion of the rotation detected by the rotation position sensor 124 may be due to the rotation of the installation tool itself. The rotation position sensor 124 alone cannot detect a change in the overall position of the installation tool. The tool rotation detector 126 is configured to detect changes in the overall rotational position of the installation tool and thus provides a “correction factor” to the data provided by the rotation position sensor 124. That is, the amount of rotation of the installation tool 102 itself, detected by the tool rotation detector 126 can be added or subtracted (depending on the direction of rotation of the installation tool 102) to the data generated by the rotation position sensor 124 to thereby generate accurate rotation position data with respect to the fastener being installed.

The tool rotation detector 126 may be implemented in a variety of different manners. In one implementation, the reader 120 may be a video device to read the printed symbology 122 and to further note an initial position of the printed symbology 122, as illustrated in FIG. 3. If the assembly worker rotates the installation tool 102 during the installation process, the change in the orientation of the printed symbology 122 with respect to its initial position may be calculated to determine the amount of rotation of the installation tool itself. Thus, the printed symbology 122 as illustrated in FIG. 3 acts as a landmark that provides an indication of the initial position of the installation tool and thereby provides a measure of tool rotation during the installation process.

In an alternative embodiment, the reader 120 is a conventional bar code scanner and the tool rotation detector 126 is implemented as a video device to measure the printed symbology independent of the reader 120. In this embodiment, the printed symbology still acts as a landmark reference to detect an initial orientation of the installation tool 102 and to thereby detect rotational changes in the orientation of the installation tool during the installation of the fastener.

In yet another alternative embodiment, the tool rotation detector 126 may be implemented using a conventional rotational accelerometer or gyroscope. Those skilled in the art will appreciate that the rotational accelerometer measures the angular acceleration around the motor rotational axis. The angular acceleration measurement can be processed by conventional electronic circuitry to generate a measurement of rotational angle. For example, those skilled in the art will recognize that the angular acceleration value may be integrated twice to produce a rotational angle measurement. A gyroscope will provide a direct measurement of the rotational output angle. When used to implement the tool rotation detector 126, the rotational accelerometer or gyroscope may be oriented to provide an indication of the orientation of the installation tool 102 at the time of initial installation of the fastener by measuring the change of rotational position between the start of rotation to the rotational position of succeeding points in time during the installation. The output of the rotational accelerometer or gyroscope is further monitored during the installation process to detect any rotation of the installation tool 102 itself. Thus, the accelerometer provides an indication of any rotation of the installation tool 102 during the installation process. Other known techniques may be satisfactorily used to implement the tool rotation detector 126. The system 100 is not intended to be limited by any specific form of the tool rotation detector 126.

The ADC 118, reader 120, rotation position sensor 124, and tool rotation detector 126 are coupled to the computer 104 via respective communication links 128. Those skilled in the art will appreciate that the communication links 128 may be implemented as a conventional cable. Alternatively, the communication links 128 may be implemented via a wireless connection. Short range wireless connections, such as Bluetooth, are known in the art and need not be described in greater detail herein.

The computer 104 includes a central processing unit (CPU) 130 and a memory 132. The CPU 130 may be implemented by any number of known technologies, such as a microprocessor, microcontroller, programmable gate array, application specific integrated circuit (ASIC), or the like. The specific implementation of the CPU is not critical to successful operation of the computer 104.

Similarly, the memory 132 may be implemented using a variety of known memory technologies. The memory 132 may include random access memory (RAM), read-only memory, programmable memory, or the like. The computer 104 is not limited by the specific technology used to implement the memory 132. In general, the CPU 130 receives data and instructions from the memory 132 and executes those instructions.

In some embodiments the computer 104 also includes a data storage device 134. The data storage device 134 may be implemented as one or more conventional storage devices. For example, the data storage device 134 may comprise a magnetic disc drive, optical drive, flash memory, or the like. The computer 100 is not limited by the specific implementation of the data storage device 134.

The computer 104 also includes a signature storage structure 136. As will be described in greater detail below, the signature storage structure 136 stores gold standard signatures that are unique to each fastener type. The gold standard signature is compared to the real-time or near real-time installation signature generated by the installation tool 102. In this manner, the actual data generated during installation of the fastener results in an installation signature that is compared with the gold standard fastener signature to determine whether the correct fastener was properly installed. The signature storage structure 136 is illustrated as a separate block in the functional block diagram of FIG. 1 because it serves a separate functional purpose. However, those skilled in the art will appreciate that the signature storage structure 136 may be part of the memory 132 or stored within the data storage device(s) 134.

The computer 104 also includes a timer 138 used to collect data with which to generate the signature patterns. The timer 138 is a conventional component whose operation need not be described in greater detail. A conventional microprocessor chip used to implement the CPU 130 often includes one or more timers that may be used to implement the timer 138.

The computer 104 also includes one or more input/output (I/O) interfaces 140. In the example illustrated in the functional block diagram of FIG. 1, the I/O interfaces 140 provide an interface with the ADC 118 and the reader 120. Those skilled in the art will appreciate that the I/O interfaces 140 are conventional components that may be varied to fit the functional requirements. For example, an I/O interface for the ADC 118 is well known in the art and need not be described in greater detail herein. Furthermore, the I/O interface 140 used to communicate with the reader 120 is also known in the art and need not be described in greater detail.

In addition, the computer 104 includes conventional components such as a keyboard, display, and cursor control device. Each of these various devices may communicate with the computer 104 via the I/O interfaces 140. For the sake of clarity, those conventional components are not illustrated in the functional block diagram of FIG. 1.

The various components of the computer 104 are coupled together by a bus system 142. The bus system 142 may include an address bus, data bus, control bus, power bus, and the like. For the sake of clarity, those various busses are illustrated in FIG. 1 as the bus system 142.

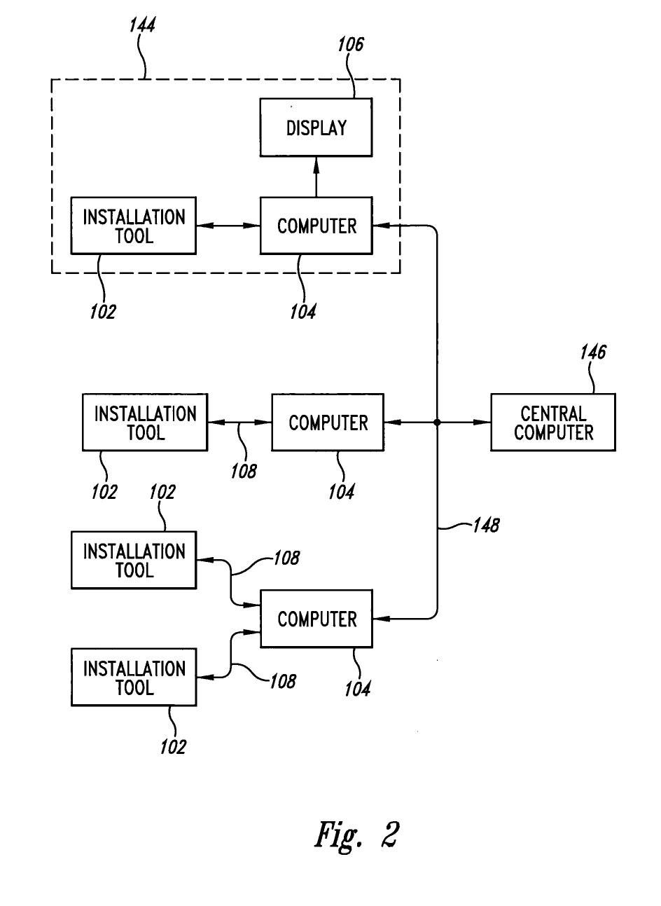

In addition, the computer 104 may include other I/O interfaces 140. For example, the computer 104 may include a network interface controller (NIC) to allow the computer 104 to communicate with a central computer system 146 (see FIG. 2). This may be advantageous in a factory setting in which many computers 104 may be distributed throughout the factory. FIG. 2 illustrates a variety of architectural implementations possible for the system 100. In one implementation, the installation tool 102 and computer 104 may integrated into a single integrated installation tool 144. Those skilled in art will appreciate that miniaturization of circuitry as well as the use of specialized circuitry, such as an ASIC or microcontroller, could be used to implement the computer 104. The miniaturized components may be added to the installation tool to create the integrated installation tool 144 illustrated in FIG. 2.

In this implementation, the data necessary for proper operation and torque detection (e.g., waveform data and/or torque signature data) may be downloaded into the integrated installation tool 144. A simple indicator display 106, such as a red/green light or a small alpha-numeric display to indicate pass/fail to the assembly worker. In the event of failure, the assembly worker may remove the defectively installed component and re-install the fastener properly.

In another implementation, the installation tool 102 may be directly coupled to the computer 104 via a connection 108, such as a conventional cable, wireless connection, or the like. In yet another example, multiple installation tools 102 may be coupled to a single computer 104 via one or more connections 108. This implementation may be advantageous when multiple installation tools are associated with a particular work station in an assembly line or other location in a factory. The convenience of having a single computer 4 communicate with multiple installation tools 102 may also serve to reduce cost.

In the example embodiments illustrated in FIG. 2, each of the plurality of computers 104 collects data and reports quality assurance data back to the central computer 146 via the NIC I/O interface 140. The central computer 146 may communicate with the plurality of computers 104 via a network 148. The network 148 may be implemented as a local area network (LAN), a wide-area network (WAN), or a combination of the two. Portions of the network 148 may be implemented by conventional wireless technologies. For example, the integrated installation tool 144 may communicate with the central computer 148 via a wireless implementation of the network 148. In some implementations, the Internet may be used as a part of the WAN. The central computer 146 can maintain a quality assurance database or other convenient data structure that will have specific data for each article of manufacture. This record may be produced as part of a final assembly process or maintained for subsequent quality assurance evaluation purposes.

In one embodiment, the signature storage structure 136 may be physically located in the central computer 146. The computer 104 can transmit the identification data derived from the printed symbology 122 and request download of the associated gold standard fastener signature. This distributed architecture allows a central storage location of gold standard signature patterns to be readily updated rather than require updating of each individual computer 104 with the appropriate gold standard signature patterns.

FIG. 3 diagrammatically illustrates the installation tool 102 and the printed symbology 122. As previously discussed, the printed symbology 122 uniquely identifies the location at which a fastener 150 will be installed. FIG. 3 illustrates the fastener 150 as a bolt inserted at the location indicated by the printed symbology 122. However, those skilled in the art will appreciate that the fastener 150 may be, by way of example, a nut to be installed on a threaded rod or stud extending outwardly at the location indicated by the printed symbology 122. Furthermore, those skilled in the art will appreciate that the printed symbology 122 may be implemented in a variety of different forms. For example, the printed symbology 122 may be implemented as a bar code in a predetermined position near the location at which the fastener 150 will be installed. In this implementation, the installation tool may need to be positioned at a predetermined orientation with respect to the fastener location. This implementation may also help by requiring the assembly worker to consistently position the installation tool 102 at a desired initial orientation. This can assist the tool rotation detector 126 (see FIG. 1) by consistently positioning the installation tool 102 at a fixed initial orientation.

The installation tool 102 includes a fastener driver tool 152 and a rotating driver tool chuck 154. The driver tool chuck 154 allows interchangeability of the fastener driver tool 152. For example, in one embodiment, the fastener driver tool 152 may be socket driver sized to accommodate the particular fastener for the particular location indicated by the printed symbology 122.

In an exemplary embodiment, it is desirable, from a quality assurance perspective, to include a technique to uniquely identify the installation tool 102 being used to install a particular fastener. Those skilled in the art will appreciate that the wrong installation tool 102 or a defective installation tool may result in manufacturing defects. If the installation tool 102 and computer 104 are integrated into the integrated installation tool 144 (see FIG. 2), data within the computer 104 may be used to uniquely identify the integrated installation tool. If the installation tool is coupled to the computer by the connection 108 (see FIG. 2), circuitry within the installation tool 102 may be used to uniquely identify that tool. If the incorrect installation tool is being used, the current controller 116 (see FIG. 1) may be instructed to limit current and thereby disable the improperly selected installation tool. An incorrect installation tool may also be reported to the central computer 146 (see FIG. 2) for quality assurance purposes.

Also illustrated in FIG. 3 is the reader 120 (see FIG. 1). The reader 120 reads the printed symbology 122 and uniquely identifies the location at which the fastener 150 will be installed. Based on data stored in the computer 104, the system 100 identifies the type of fastener that will be installed at the specific location and also identifies the gold standard fastener signature associated with the fastener 150 for the indicated location.

In one embodiment, the reader 120 is also configured to determine the rotational orientation of the fastener 150. That is, the printed symbology 120 may be used as a rotational position indicator detected by the reader 120 and used to compare data generated by the installation tool 102 with the stored signature pattern for the fastener 150 and the location identified by the printed symbology 122. Alternatively, the rotation position sensor 124 and tool rotation detector 126, which are embedded within the housing of the installation tool 102, may be used to determine the rotation of the fastener 150 as well as rotation of the installation tool 102 itself.

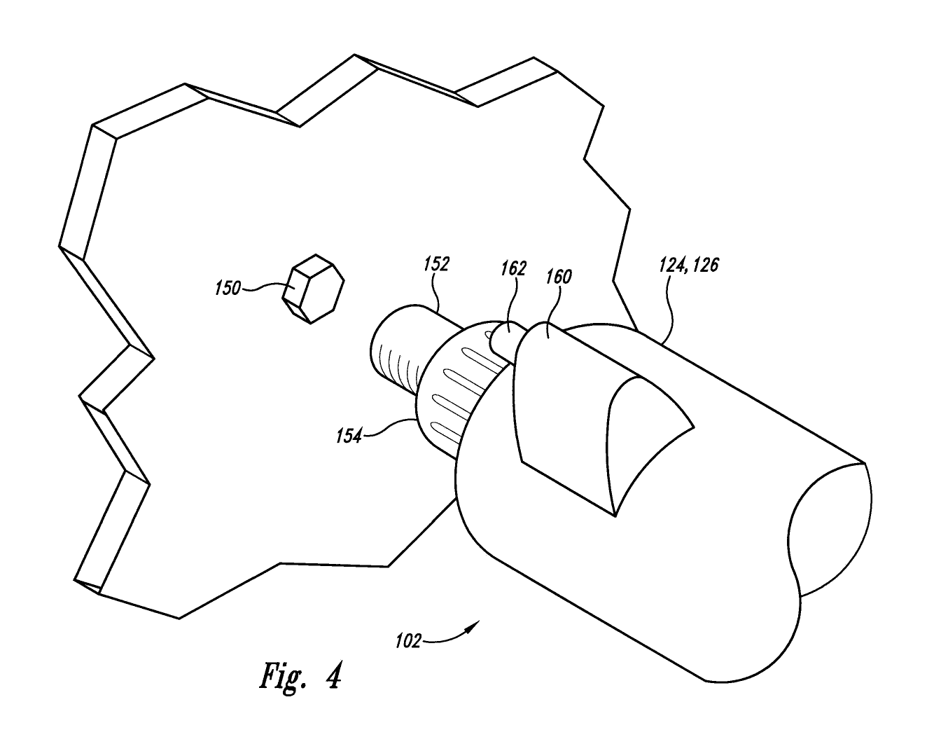

FIG. 4 illustrates an alternative embodiment of the installation tool 120 in which a camera 160 and camera lens 162 are mounted in fixed position on the installation tool 102. As previously described, the rotation position sensor 124 and tool rotation detector 126 of FIG. 1 are contained within the body of the installation tool 102. In this embodiment, the camera 160 can identify the installation location and thereby uniquely identify the fastener 150 to be installed at that location. Based on this identification, the gold standard fastener signature stored in the signature storage structure 136 (see FIG. 1) for that fastener may be identified. In one embodiment, the camera 160 may also be used to determine the initial angular orientation of the installation tool 102 with respect to the installation location. Thus, the camera 160 may used to monitor the installation tool 102 for possible undesirable rotation by the assembly worker during the installation process. Alternatively, the installation tool 102 may include the tool rotation detector 126 of FIG. 1.

As previously discussed, conventional installation tools 120 may include torque measuring capability. As illustrated in FIG. 1, the current sensor 114 may detect the current associated with the power tool motor 110 to thereby determine torque at any given moment. Periodic or continuous measurements of torque will provide a measurement of torque versus time. The installation tool 102 is modified to include the reader 120 and/or the camera 160.

The system 100 uses a torquing tool (e.g., the installation tool 102) that has built-in means to continuously measure the torque being applied, the relative rotational position of the torque tool, and means to determine at which fastener location the fastener is being installed. The system 100 can determine the appropriate measurement data for a particular fastener location by observing the location information provided by the printed symbology 122. The length of the fastener 150 is known because the number of turns that the fastener is turned before tightening is measured and known. This data may be stored in the signature storage structure 136 (see FIG. 1). The system 100 can determine if the thread fit and the threads are defect-free and burr-free by measuring the torque during the process of spinning the fastener 150 on the location identified by the printed symbology 122. Since the speed of the fastener spin is being measured, and, if desired, can be held constant, the system 100 can compensate for torque variations due to spin speed. The finish torque is known because it is measured in the manner described above. With some installation tools 102, the finish torque value can be predetermined and the tool can be programmed to automatically stop when the desired torque valve is reached. Variations in fastener installation, such as stopping and restarting, twisting the installation tool 102 while the fastener 150 is being installed are all measured for each fastener installation. The torque applied by the installation tool 102, adjusted for speed of application, is plotted against the angle of rotation to create what is referred to as the fastener torque signature. The fastener torque signature is stored in the signature storage structure 136 (see FIG. 1). Analysis of the fastener torque signature determines whether the correct fastener 150 was properly installed and defect free.

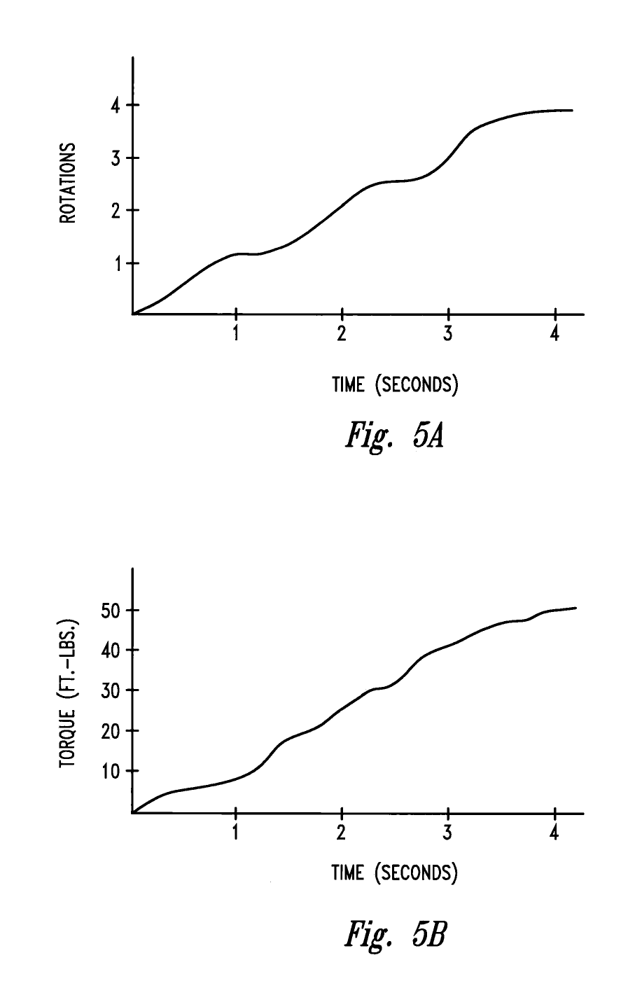

FIGS. 5A and 5B illustrate data used to create the fastener signature. Those skilled in the art will appreciate that the fastener signature may be unique for each different type of fastener. For example, a large diameter fastener will have a different fastener signature than a small diameter fastener. A short length fastener may have a different fastener signature than a long length fastener of the same diameter. Even fasteners of the same diameter and length are available in coarse threads and fine threads. The fastener signature may be different for a coarse-threaded fastener versus a fine-threaded fastener. The system 100 can accommodate a large number of different fasteners and determine a unique fastener signature for each fastener.

The waveform of FIG. 5A provides a measure of the rotations of the fastener 150 with respect to time. In the example of FIG. 5A, the fastener undergoes four rotations over the measured time period. At the same time, the torque applied to the fastener 150 is measured over the same time period. FIG. 5B illustrates torque with respect to time. That is, the waveform of FIG. 5B illustrates the torque generated by the installation tool over the same installation time period as shown in FIG. 5A. Because of the common time scale, torque with respect to rotational position can readily be determined. For example, the rotational position at one second can readily be determined using the data in FIG. 5A, while the torque value for that rotational position is the torque value at one second as shown in the waveform of FIG. 5B. In FIG. 5A, the vertical axis may be broken in to any number of gradations, such as one degree increments thus subdividing the distance between zero and one revolutions of the fastener 150, for example into 360 measurements corresponding to 360° in a single revolution. For each degree (or other measurement increment) it is possible to match the rotation position to a particular torque value on the curve in FIG. 5B. Thus, in the example described above, it is possible to determine the torque at each one degree increment as the fastener is rotated. This results in data that matches the torque value with the rotational value of the fastener at the particular installation site.

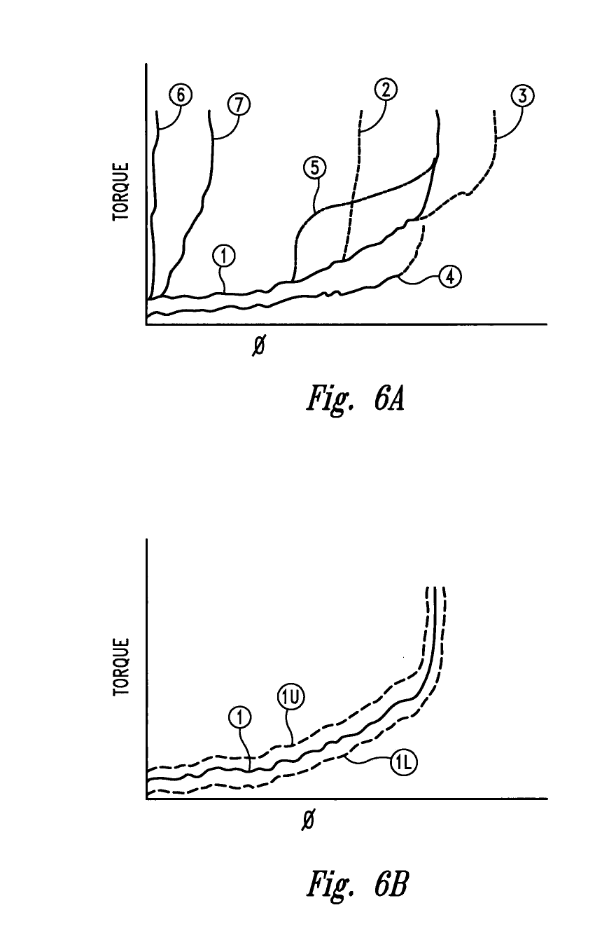

FIG. 6A shows examples of fastener signatures for a correctly installed fastener and for different types of defects. The information gathered by the reader 120 and the printed symbology 122 is used to determine the fastener location. This information, taken as a whole, provides means to insure all fasteners are properly installed eliminating defective components, improper components, burr and/or shavings in/on the threads, and operator error.

Waveform 1 in FIG. 6A is an example of a normal fastener signature. The various curves illustrated in FIG. 6A plot torques as a function of the rotational position of the fastener (e.g., the fastener 150 of FIG. 2). With respect to waveform 1, the torque increases as additional threads of the fastener are engaged. When the final threads of the fastener are engaged, the torque value sharply increases to indicate that the fastener is no longer rotating. A final torque value can be determined to assure that the fastener is tightly secured at the proper torque value.

Waveform 2 of FIG. 6A illustrates an example fastener signature when an improper fastener has been selected. In the example of waveform 2, the fastener is too short. As illustrated in waveform 2, the torque value follows a relatively normal pathway of waveform 1 until it bottoms out sooner than would be expected. The sudden rise in torque value to the final torque value indicates that the fastener is properly tightened. However, the final torque value was achieved too soon, thus indicating that the fastener was too short. In contrast, waveform 3 in FIG. 6A is a typical example of a fastener signature when the fastener is too long. Again, the fastener follows the normal fastener signature of waveform 1, but continues to increase gradually until it suddenly increases and reaches a final torque value. However, the deviation from the normal fastener signature (i.e., waveform 1) indicates that additional rotations occurred, thus providing a signature indicative of a fastener that is too long.

Waveform 4 in FIG. 6A illustrates a fastener signature indicative of a fastener that is too small a diameter. As illustrated in FIG. 6A, the waveform 4 begins with a lower torque value than the normal fastener signature of waveform 1. If the fastener is significantly smaller than the hole, the threads will slip. In this case, the torque required to spin the fastener is too low, as illustrated by the solid portion of waveform 4 in FIG. 6A. The fastener may continue to slip with the result that the torque value does not change significantly as a function of the rotational position of the fastener. The system 100 can be configured to detect the condition illustrated in waveform 4 (i.e., a torque value that does not change significantly with respect to rotational position) and activate the current controller 116 (see FIG. 1) to cut off power to the installation tool 102. This will avoid damage to the fastener and to the equipment under assembly.

In another situation, the incorrect fastener may be only slightly too small for the hole. In this case, the initial torque required to rotate the fastener may be lower than the normal fastener torque signature of waveform 1, but may ultimately rise to some reasonable torque level, as indicated by the dashed portion of waveform 4. However, the system still detects this defect due to the low initial torque value with respect to the rotational position of the fastener. Further, the final torque value achieved in waveform 4 may still be unacceptably low with respect to the final torque value in the normal fastener signature of waveform 1. Thus, the system 100 would still indicate that the fastener is improperly installed.

Waveform 5 in FIG. 6A is an example of an illustration of a fastener signature for a fastener that has a thread defect or a possible metal shaving associated with the fastener or the threaded bore into which the fastener is inserted. In the example of waveform 5, the initial fastener signature follows closely with the normal fastener signature illustrated by waveform 1. However, at the point where the thread defect or metal shaving begins to bind the fastener, the torque value undergoes a sharp increase prematurely as compared with the normal fastener signature of waveform 1. Although the final torque value may be similar to that in waveform 1, the deviation illustrated in the example of waveform 5 shows that an unexpected problem was encountered.

The example of waveform 6 in FIG. 6A illustrates a fastener signature for a previously installed fastener. In this example, the final torque value is rapidly achieved with no rotations of the fastener. This serves as an indication that the particular fastener has already been installed and tightened to the proper final torque value or higher.

Waveform 7 of FIG. 6A is an example fastener signature of a fastener that has too large a diameter or an improper thread match or a cross-threaded fastener. For example, the selected fastener could have the wrong thread spacing or could be fine threads when coarse threads are required (or vice versa). The fastener signature illustrated in waveform 7 shows that the torque value rapidly rises after a very short rotation period indicating that the threads are encountering significant resistance from the outset. Although the final torque value is achieved, waveform 7 illustrates that there were not enough revolutions of the fastener. Thus, the fastener is improperly installed.

Waveforms 6 and 7 in FIG. 6A serve to illustrate an example of a previously installed fastener (i.e., waveform 6) or an improperly selected fastener or cross-threaded fastener (i.e., waveform 7). However, as previously discussed, the current controller 116 (see FIG. 1) can be used in conjunction with the current sensor 114, rotation position sensor 124 and tool rotation detector 126 to detect such conditions. In a situation where the torque value increases too rapidly, the current controller 116 may limit current to the power tool motor 110 and thus limit rotation for any torque level that exceeds a predetermined value for a predetermined angle of rotation. This will serve to prevent thread damage to the fastener or the location at which the fastener will be installed. In the absence of the system 100, conventional installation of cross-threaded fasteners often lead to a broken fastener or a jammed fastener. As a result, the fastener must often be drilled out and the hole re-tapped to a larger, non-standard size. As a result, the piece of equipment being manufactured may have a non-standard fastener in one location as a result of the improperly selected or cross-threaded fastener. The system 100 prevents such damage by quickly limiting the current controller 116 to stop rotation of the power tool motor 110 if the torque value increases too rapidly and does not follow the normal expected fastener signature (i.e., waveform 1 in FIG. 6A). The example signature waveforms in FIG. 6A provide examples of a normal expected signature (i.e., waveform 1) or a fastener signature of an already installed fastener (i.e., waveform 6) as well as sample fastener signatures for improperly installed fasteners (i.e., waveforms 2-5, and 7). The system 100 is capable of detecting a number of different problems with fastener installation based on the installation signatures.

FIG. 6B illustrates the expected fastener signature as waveform 1. Waveform 1L and waveform 1U graphically illustrate limits to the torque signature value that may still be considered acceptable. In one implementation, a measured torque signature indicates that the fastener is properly installed if it falls between the lower and upper limits graphically illustrated by waveforms 1L and 1U, respectively.

Although implementation of the system 100 is more readily understood using the graphical illustrations of waveforms in FIGS. 5A-5B and the waveforms of FIGS. 6A-6B, those skilled in the art will appreciate that the system 100 need not be based on graphical waveform analysis. In a typical implementation, the system 100 will store data associated with the graphical illustration of the waveforms and perform a data analysis rather than a graphical waveform analysis. For example, the waveforms of FIGS. 5A-5B are based on data points collected during the installation of the fastener 150. These data points are typically collected at discrete periods of time and may be stored in a database, or other convenient data structure for subsequent analysis. After the rotation and torque data with respect to time is collected, the data may be manipulated to generate the installation signature, which relates torque data to rotational angle.

The torque versus rotational angle data is also illustrated graphically in FIGS. 6A-6B. However, the system 100 may typically generate data associated with the waveforms and store such data in a database or other convenient data structure. Thus, the fastener signature is typically generated and analyzed as a set of data points rather than a visual waveform, such as illustrated in FIGS. 6A-6B.

Similarly, the analysis of actual fastener installation with respect to the gold standard fastener signature is illustrated graphically in the waveforms of FIG. 6B, which shows an upper and lower limit to the normal torque signature pattern. However, a typical implementation of the system 100 collects torque data during the installation of a fastener and compares the installation signature with the already collected gold standard fastener signature.

Analysis of the installation signature with respect to the gold standard fastener signature may also take a variety of forms that are not limited to graphical waveform analysis. Those skilled in the art will appreciate that a variety of different measures can be used to determine whether a particular fastener was properly installed at the proper location and whether the fastener was defect-free. For example, the analysis of the installation signature with respect to the gold standard fastener signature may include a measure of initial torque, the slope of the torque with respect to selected portions of the rotation data, the final torque value, the initial slope value at the start of installation, the slope of the torque value at final installation, torque values at discrete points in time, and the like. The basic information required to determine a Pass/Fail installation for a particular fastener includes the data required to generate an installation fastener signature. This includes periodic measurements of torque, angular position, and speed of rotation of the fastener with respect to the mating fastener at the installation location. The timer 138 is used as a clock reference to allow speed to be determined as a measure of change of rotation over some period of time. The fastener torque signature may be thought of as a three-dimensional plot of torque, angular position, and speed. However, by holding the speed of the installation tool 102 at a constant level, or by making corrections for speed changes, it is possible to represent the fastener torque signature as a two-dimensional plot of torque and angle. Thus, analysis of the installation signature with respect to the gold standard fastener signature need not be limited to a waveform analysis or some data point-by-data point analysis.

Thus, the system 100 may make use of a limited number of “markers,” such as those described above, to adequately ensure that a fastener is properly installed. Those skilled in the art will appreciate that the use of such markers lends itself to statistical analysis for the results for quality assurance purposes. In addition, this data may be used to determine when tools (e.g., the installation tool, taps, threading tools, and the like) need to be replaced.

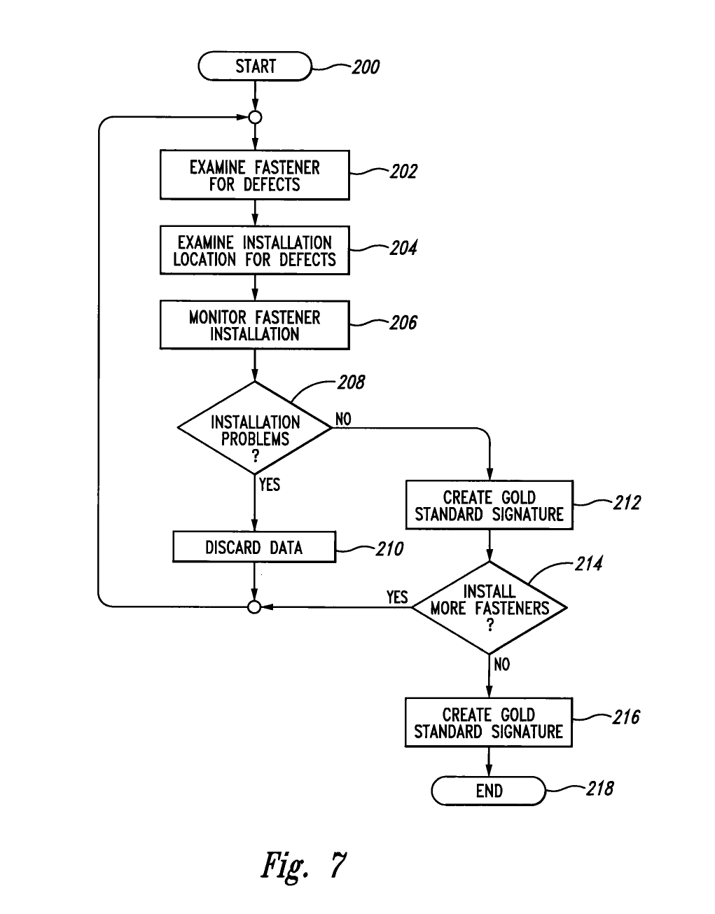

FIG. 7 is a flow chart illustrating the operation of the system 100 to initially create a gold standard fastener signature. At a start 200, a particular fastener location has been identified. In step 202, the user must manually examine the fastener for defects. It is desirable that the normal fastener torque signature be derived using defect-free fasteners, which will serve as the standards for subsequent installation. For the measurement of a gold standard signature a fastener is manually inspected and carefully installed so as to derive the appropriate fastener signature data, which may be used to perform subsequent automatic analysis of fastener installation.

In step 204, the user examines the installation location for defects.

In step 206, the system 100 monitors fastener installation in the manner described above. That is, the installation tool 102 is used to install the fastener at the desired location and rotation and torque data collected with respect to time. In decision 208, the user determines whether there were any installation problems associated with this gold standard fastener. If any anomalies were detected, the result of decision 208 is YES and in step 210, the data is discarded.

If no installation problems were detected, the result of decision 208 is NO and in step 212, the system 100 creates the gold standard fastener signature. As previously discussed, this may involve a conversion of the torque and rotation data with respect to time (see, e.g., FIGS. 5A-5B) into torque data with respect to rotational position (see, e.g., FIGS. 6A-6B). As noted above, the creation of the gold standard fastener signature may involve the use of all data points during the installation process or simply selected data points. In addition or in the alternative, the gold standard fastener signature may include other values, such as the initial and end torque values, the slope at the initial and end torque values, intermediate slope values, and the like. The final gold standard fastener signature may include one or more of these data values.

In decision 214, the user may decide to install more fasteners. In some instances, it may be desirable to install several gold standard fasteners and to combine the data from each installation. The data could be averaged, or high and low values thrown out, with the intermediate values being averaged, or manipulated in any other known fashion. If the result of decision 214 is YES, the system returns to step 202, where the user may inspect another fastener and installation location for defects and repeat the measurement process. If no more fasteners are to be installed and data collected for the gold standard fastener signature value, the result of decision 214 is NO. In that event, in step 216, the system 100 stores the gold standard fastener signature in the fastener signature storage location 136 (see FIG. 1) and the process ends at 218. In this manner, the user has created a gold standard fastener signature that is unique to the particular fastener. While the initial creation of the gold standard fastener signature may require careful inspection to assure defect-free fasteners, the subsequent installation of fasteners by an assembly worker may be done in an automated fashion with the actual fastener installation signature being collected and analyzed with respect to the gold standard fastener signature for that particular fastener at that particular location.

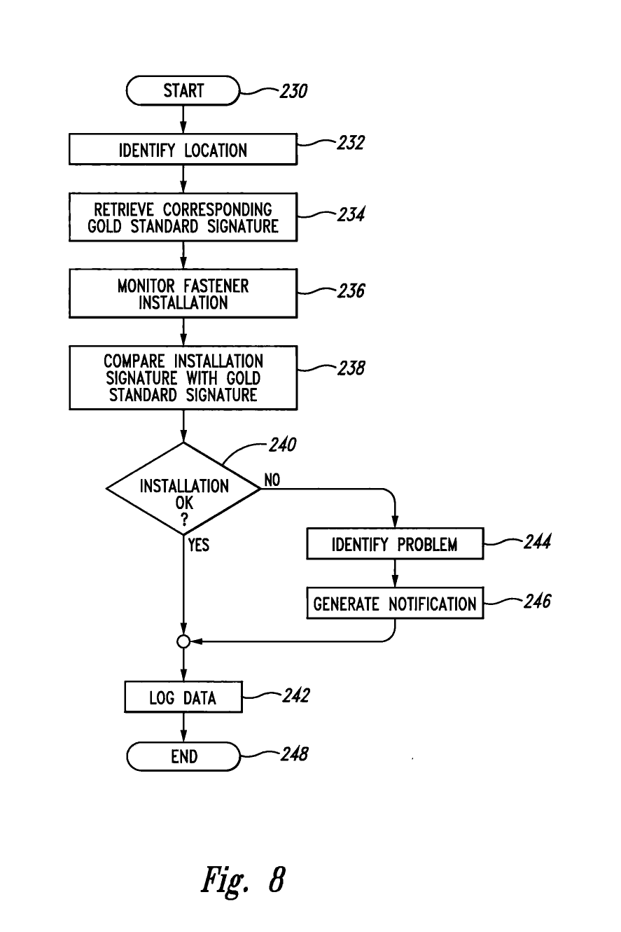

FIG. 8 is a flow chart illustrating the operation of the system to generate an installation signature during the actual assembly process and to analyze the installation signature with respect to the stored gold standard fastener signature. At a start 230, the computer 104 (see FIG. 1) is operational. In step 232, the system 100 determines the location at which a particular fastener will be installed. As previously discussed, that identification may be performed by the reader 120, reading a printed symbology 122 or by the camera 160 reading the printed symbology or uniquely identifying the location using well known image analysis techniques to precisely identify the location at which a fastener will be installed. Whatever process may be used to implement the system 100, the precise location at which a fastener will be installed is uniquely identified in step 232.

In step 234, the system retrieves the corresponding fastener torque signature, corresponding to the uniquely identified location. In step 236, the system 100 monitors the fastener installation. As previously discussed, the monitor process includes measuring the rotational position of the installation tool itself, as well as the rotation of the fastener. The torque applied by the installation tool is also monitored and the torque data with respect the rotational position is used to generatean installation signature for analysis by the computer 104.

In step 238, the computer 104 compares the installation signature with respect to the gold standard fastener signature corresponding to the uniquely identified location. As previously discussed, the comparison process may be done graphically as illustrated in the waveforms of FIGS. 6A-6B. However, a more typical analysis involves the comparison of actual data points to determine the deviation, if any, of torque with respect to rotational position. The analysis may also include measures of other points, such as starting and ending values, slopes, torque values at certain points in time, and the like.

In decision 240, the system 100 determines whether the actual installation was correct. If the installation was correct, the result of decision 240 is YES and the system 100 can log the data at step 242.

If the comparison of the installation signature with the gold standard fastener signature indicates that the installation was not correct, the result of decision 240 is NO. In that event, in step 244, the system may identify the nature of the problem. The waveforms of FIG. 6A illustrate several different types of defects that may be detected by the system 100. Again, the system 100 may determine the nature of the defect using graphical waveform analysis. However, a more common implementation involves the analysis of data points or other measures, such as starting/stopping torque values, slopes, and the like.

In step 246, the system generates an error notification to indicate that the fastener installation was unacceptable. This may include an enunciator light at the assembly work station (e.g., the display 106 in FIG. 2), as well as a report to the central computer 146.

Following the generation of notification, the error data may also be logged at step 242 and the process end at 248. If a fastener installation has been identified as a problem in step 244, the assembly worker can remove the defective fastener and re-install the proper fastener, Thus, the steps illustrated in FIG. 8 would be repeated for the replacement fastener. In this manner, the system 100 can automatically analyze actual installation of each and every fastener to make sure that the proper fastener is installed at the proper location. In addition, the system 100 automatically generates data that can be used as a log for quality assurance purposes and for defect analysis purposes.

Alternative embodiments of the invention use other means to determine the fastener location, and/or to measure the torque or angular position. For example, the means of determining which fastener location is being installed could be the camera 160 located on the installation tool 102 that takes one or more pictures of the installation location and using details in the field of view of the picture to determine the precise location at which the fastener is being installed. The camera 160 can also be used to determine the angle between the installation tool and the article of manufacture by monitoring the position of a distinctive point in the field of view while the torquing process is taking place, and recording this information. This can be accomplished by taking multiple pictures, or by using image recognition technology. Another approach to determine fastener location is to locate an RFID tag near each fastener and include an RFID reader on the installation tool 102. While an RFID tag may be unsuitable for determining rotational orientation of the installation tool, it can serve to uniquely identify the location and thus uniquely identify the fastener to be installed at that location. The rotation of the fastener can be determined utilizing the rotation position sensor 124 and tool rotation detector 126, illustrated in FIG. 1. For example, an accelerometer may be utilized as the tool rotation detector 126 to measure the relative angle of the installation tool with respect to the earth's gravity.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system for fastener installation at a location using a fastener installation tool, comprising:
a torque measurement circuit configured to measure the torque applied to a fastener being installed;
a position sensor configured to determine a rotational position of the fastener with respect to a fastener mate; and
a processor configured to receive data indicative of the torque and rotational position throughout the torquing of the fastener, the processor further configured to compare the received data with a stored fastener torque signature to thereby determine whether the fastener was properly installed.

2. The system of claim 1, further comprising fastener identification means to determine the identification of the fastener being installed.

3. The system of claim 1, further comprising mating fastener identification means to determine the identification of a location of the mating fastener at which the fastener is being installed.

4. The system of claim 3 wherein the mating fastener identification means comprises a printed symbology affixed next to the mating fastener location.

5. The system of claim 3 wherein the mating fastener identification means comprises an image of the mating fastener location.

6. The system of claim 1, further comprising an encoder coupled to the installation tool to measure a relative rotational position of the fastener to the fastener mate rotational position when movement of a body of the installation tool is maintained in a fixed orientation with respect to the fastener mate.

7. The system of claim 6, further comprising an error correction circuit to compensate for rotation of the body of the installation tool with respect to the fastener mate.

8. The system of claim 7 wherein the error correction circuit comprises an imaging system to take multiple images of a location of the mating fastener at which the fastener is being installed to thereby detect rotation of the body of the installation tool with respect to the fastener mate.

9. The system of claim 7 wherein the error correction circuit comprises an accelerometer coupled to the installation tool body to thereby detect rotation of the body of the installation tool with respect to the fastener mate.

10. The system of claim 7 wherein the error correction circuit comprises a gyroscope coupled to the installation tool body to thereby detect rotation of the body of the installation tool with respect to the fastener mate.

11. The system of claim 1 wherein the fastener torque signature comprises a torque versus rotational position plot and the installation tool is designed to rotate the fastener at a constant speed to construct a torque versus rotational position plot for the fastener and the fastener mate for comparison by the processor.

12. The system of claim 1 wherein the fastener torque signature comprises data related to torque and rotational position of the fastener for a satisfactory fastener installation.

13. The system of claim 12 wherein the fastener torque signature comprises data selected from a set of data comprising an initial torque value, a final torque value, a slope of torque value during installation.

14. The system of claim 1 wherein the torque measurement circuit, the position sensor and the processor are integrated into the installation tool.

15. The system of claim 1, further comprising a remote processor configured to communicate with the processor to thereby download the fastener torque signature for storage by the processor.

16. The system of claim 1, further comprising a remote processor configured to communicate with the processor and to receive data related to the comparison from the processor.

17. The system of claim 16, wherein the remote processor is configured to use the received data related to the comparison for quality assurance of the installation.

18. The system of claim 1 for use with a plurality of installation tools, the system further comprising a remote processor configured to communicate with each of the installation tools and receive data related to the comparison from the processor for each of the plurality of installation tools.

19. The system of claim 1 wherein the processor is remote from the installation tool, the system further comprising a communication link between the installation tool and the processor.

20. The system of claim 1 for use with a plurality of installation tools, wherein the processor is remote from the plurality of installation tools, the system further comprising a communication link between each of the plurality of installation tools and the processor.

21. The system of claim 1, further comprising a display coupled to the installation tool to indicate a status of the fastener installation.

22. The system of claim 21 wherein the display is configured to indicate the status of the fastener installation as a pass/fail indication.

23. The system of claim 1 wherein the installation tool is an electrically powered installation tool.

24. The system of claim 23, further comprising a current control circuit to supply electric current to the electric installation tool and to limit electric current if the processor determines that the fastener is not being correctly installed.

25. The system of claim 1 wherein the installation tool is an pneumatically powered installation tool.

26. A method for fastener installation at a location using a fastener installation tool, comprising:
measuring the torque applied to a fastener being installed;
determining a rotational position of the fastener with respect to a fastener mate; and
comparing data indicative of the torque and data indicative of the rotational position throughout the torquing of the fastener with a stored fastener torque signature to thereby determine whether the fastener was properly installed.

27. The method of claim 26, further comprising determining the identification of the fastener being installed.

28. The method of claim 26, further comprising determining the identification of a location of the mating fastener at which the fastener is being installed.

29. The method of claim 28 wherein the mating fastener identification location determination uses a printed symbology affixed next to the mating fastener location.

30. The method of claim 28 wherein the mating fastener identification location determination uses an RFID tag affixed next to the mating fastener location.

31. The method of claim 28 wherein the mating fastener identification location determination uses an image of the mating fastener location.

32. The method of claim 26, further comprising measuring a relative rotational position of the fastener to the fastener mate rotational position using an encoder coupled to the installation tool when movement of a body of the installation tool is maintained in a fixed orientation with respect to the fastener mate.

33. The method of claim 32, further comprising generating an error correction to compensate for rotation of the body of the installation tool with respect to the fastener mate.

34. The method of claim 26 wherein the fastener torque signature comprises a torque versus rotational position plot and the installation tool is designed to rotate the fastener at a constant speed to construct a torque versus rotational position plot for the fastener and the fastener mate for comparison.

35. The method of claim 26 wherein the fastener torque signature comprises data related to torque and rotational position of the fastener for a satisfactory fastener installation.

36. The method of claim 35 wherein the fastener torque signature comprises data selected from a set of data comprising an initial torque value, a final torque value, a slope of torque value during installation.

37. The method of claim 26 wherein the torque measurement circuit, the position sensor and the processor are integrated into the installation tool.

38. The method of claim 26, further comprising downloading the fastener torque signature from a remote processor.

39. The method of claim 26, further comprising communicating with the installation tool to receive data related to the comparison.

40. The method of claim 26, further comprising displaying a status of the fastener installation on a display.

41. The method of claim 40 wherein the display is configured to indicate the status of the fastener installation as a pass/fail indication.

42. A method for fastener installation at a location using a fastener installation tool, comprising:
taking measurements of the fastener installation during installation of the fastener at a fastener mate location to thereby generate installation data;
comparing the installation data with stored data representative of a satisfactory installation; and
generating an indication whether the fastener was satisfactorily installed.

43. The method of claim 42 wherein taking measurements comprises measuring torque applied to the fastener during installation.

44. The method of claim 42 wherein taking measurements comprises measuring rotational position of the installation tool during installation.

45. The method of claim 42, further comprising identifying the fastener mate location at which the fastener is being installed.

46. The method of claim 42 wherein the stored data representative of a satisfactory installation comprises a torque versus rotational position plot and the installation tool is designed to rotate the fastener at a constant speed wherein taking measurements of the fastener installation during installation are used to construct a torque versus rotational position plot for the fastener and the fastener mate for comparison.

47. The method of claim 42 wherein the stored data representative of a satisfactory installation comprises data related to torque and rotational position of the fastener for a satisfactory fastener installation.

48. The method of claim 47 wherein the stored data representative of a satisfactory installation comprises data selected from a set of data comprising an initial torque value, a final torque value, a slope of torque value during installation.

49. The method of claim 42 wherein taking measurements of the fastener installation is performed by the installation tool and comparing the installation data with stored data is performed by the installation tool.

50. The method of claim 49, further comprising sending data indicative of the comparison to a remote processor.

51. The method of claim 42 wherein taking measurements of the fastener installation is performed by the installation tool and comparing the installation data with stored data is performed by a processor remote from the installation tool, the method further comprising sending the installation data from the installation tool to the remote processor.

52. The method of claim 42 for use with a plurality of installation tools wherein taking measurements of the fastener installation is performed by each of the plurality of installation tools and comparing the installation data generated by each of the plurality of installation tools with stored data is performed by a processor remote from the plurality of installation tools, the method further comprising sending the installation data from each of the plurality of installation tools to the remote processor.

53. The method of claim 52 wherein each of the plurality of installation tools is installing a different fastener at a different fastener mate location than others of the plurality of installation tools to thereby generate different installation data for each of the respective fastener installations and taking measurements of the fastener installation is performed by each of the plurality of installation tools,
wherein the installation data generated by each of the plurality of installation tools is compared with different stored data representative of a satisfactory installation for each of the respective fasteners.
